(19) United States
(12) Patent Application Publication
(10) Pub. No.: US 2009/0323365 A1
(43) Pub. Date: Dec. 31, 2009

(54) LIGHTING APPARATUS

(75) Inventor: Tsutomu Ochiai, Yokohama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YAMAGATA PROMOTIONAL ORGANIZATION FOR INDUSTRIAL TECHNOLOGY, Yamagata-shi (JP)

(21) Appl. No.: 12/491,586

(22) Filed: Jun. 25, 2009

(30) Foreign Application Priority Data
Jun. 27, 2008 (JP) 2008-168800

(51) Int. Cl. F21S 8/00

(52) U.S. Cl. 362/419

(57) ABSTRACT

It is provided with a light emitting panel 2 in which a light emitting part 5 formed of an organic EL element (for example) is mounted at one surface, a panel support member 3 for swivelingly supporting the above-mentioned light emitting panel through a first connection part (hinge member) 6 at a lower end of the above-mentioned light emitting panel, and a seat 4 for swivelingly supporting the above-mentioned panel support member through a second connection part (pivot mechanism) 7 at a lower end of the above-mentioned panel support member. The light emitting part 5 in the above-mentioned light emitting panel is arranged such that a depression angle and an elevation angle can be adjusted by the above-mentioned first connection part 6 and a horizontal orientation can be adjusted by the above-mentioned second connection part 7.

### BACKGROUND OF THE INVENTION

1. Field of the Invention

The present invention relates to a lighting apparatus which is particularly suitable for indirectly illuminating a part of footlights (step light) etc., by means of a plane light source represented by, for example, an organic EL (electroluminescence) element.

2. Description of the Related Art

In an event place, a hall facility, etc., their corridors and stairs etc., footlights which mainly illuminate a step portion have been conventionally employed. Most of the conventional footlights are arranged such that a light source is embedded in a wall close to the lowermost part of the above-mentioned event place or the hall facility. As disclosed in Japanese Patent Application Publication (KOKAI) No. H9-282911, and Japanese Patent Application Publication (KOKAI) No. H10-97804, it is arranged that, for example, an electric bulb as the light source is accommodated in the main part of a lighting device, which is covered with a translucent cover made of a milk-white acrylic resin etc.

In the footlights having the above-mentioned structure, since the main part of the lighting device having accommodated therein the electric bulb is post-installed at the wall, it needs construction work, such as drilling the wall etc. For this reason, there are many constraints, such as construction expense, needing a somewhat long construction period, etc. Further, it also has a problem that there is the necessity of taking into consideration the provision for heat radiated from an electric bulb etc.

Incidentally, in these days, an organic EL element is proposed which functions as a plane light source. This organic EL element has high luminous efficiency since it is driven by a low DC voltage. Further, it is characterized in that it can be lightweight and thinned as well as generates substantially no heat.

Furthermore, by selection of a material used for an EL light-emitting layer, the organic EL element can provide any one of luminescence colors of R (red), G (green), and B (blue). Therefore, one of the above-mentioned luminescence colors may be used independently. Alternatively, two or more luminescence colors may be combined to obtain white or nearly white luminescence color. Therefore, the organic EL element may be arranged as the plane light source (light emitting panel) so as to be used as the light source for decoration, and an efficient light source which illuminates the interior of a room etc., for example.

### SUMMARY OF THE INVENTION

Instead of lighting apparatuses, such as conventional footlights etc. which accommodate an electric bulb in a light source, the present invention aims at providing a lighting apparatus using a plane light source represented by the above-mentioned organic EL element. According to circumstances of an installation site, a layout and an irradiation angle can be changed freely, and it aims at providing a lighting apparatus excellent in decoration effect to allow calm circumstances by mainly illuminating a step etc. indirectly.

A basic structure of the lighting apparatus in accordance with the present invention made in order to solve the above-mentioned problem is provided with a light emitting panel in which a light emitting part is formed at least at one surface, a panel support member for swivelingly supporting the above-mentioned light emitting panel through a first connection part at an end of the above-mentioned light emitting panel, and a seat for swivelingly supporting the above-mentioned panel support member through a second connection part at a lower end of the above-mentioned panel support member. The light emitting part in the above-mentioned light emitting panel is characterized by being arranged such that at least a depression angle and an elevation angle can be adjusted by the above-mentioned first connection part and a horizontal orientation can be adjusted by the above-mentioned second connection part.

In this case, in the preferred embodiments, it is arranged that the above-mentioned light emitting panel and the panel support member are formed in the shape of a rectangular panel respectively, and the above-mentioned light emitting panel and the panel support member are connected together at a side for each through a hinge member which constitutes the above-mentioned first connection part. It is preferably arranged that the above-mentioned panel support member is rotatably set up on the above-mentioned seat through a pivot mechanism which constitutes the above-mentioned second connection part.

In addition, it is preferably arranged that a detent mechanism is further provided for the above-mentioned first connection part and/or second connection part, and the above-mentioned light emitting panel may be stopped by the above-mentioned detent mechanism.

Further, it is desirable that the above-mentioned light emitting part is constituted by the organic EL element and the above-mentioned seat is constituted by a casing. Preferably, a drive power-source unit for lighting and driving the above-mentioned light emitting part is accommodated in the above-mentioned casing.

According to the lighting apparatus having the above-mentioned structure, by arranging a plurality of the lighting apparatuses at intervals, for example, in an event place, a hall facility, and along the walls of their corridors and stairs etc., and by setting them so that the above-mentioned light emitting panel side may face towards the walls by means of the first and second connection parts respectively, it is possible to demonstrate the function as footlights which indirectly illuminate steps.

In this case, as it is arranged that the detent mechanism is further provided for the first and second connection parts, each light emitting panel may be stopped in any position (attitude), and it can be easily handled. In addition, since each of the above-mentioned lighting apparatuses can be laid out independently as desired, it is possible to aim at not only the above-mentioned function of footlights but also good stage effects and circumstances, and it is possible to demonstrate the lighting effect excellent in decoration effects.

Further, by using the organic EL element as the light emitting part mounted to the above-mentioned light emitting panel, it can demonstrate excellent operational effects as a lighting apparatus having high luminous efficiency, being lightweight, and generating substantially no heat.

### BRIEF DESCRIPTION OF THE DRAWINGS

FIG. 1 is a perspective view from above of a lighting apparatus in accordance with the present invention at some angle on the front side.

FIG. 2 is a perspective view from above of the lighting apparatus at some angle on the back side.

FIG. 3 is a schematic view for explaining an example of a structure of an organic EL element as a plane light emitting part.

FIG. 4 is an enlarged view from behind the principal parts of the first connection part and the second connection part.

FIG. 5 is an enlarged sectional view showing a structure of a hinge member as the first connection part.

FIG. 6 is an enlarged sectional view showing a structure of a pivot mechanism as the second connection part.

### DESCRIPTION OF THE PREFERRED EMBODIMENTS

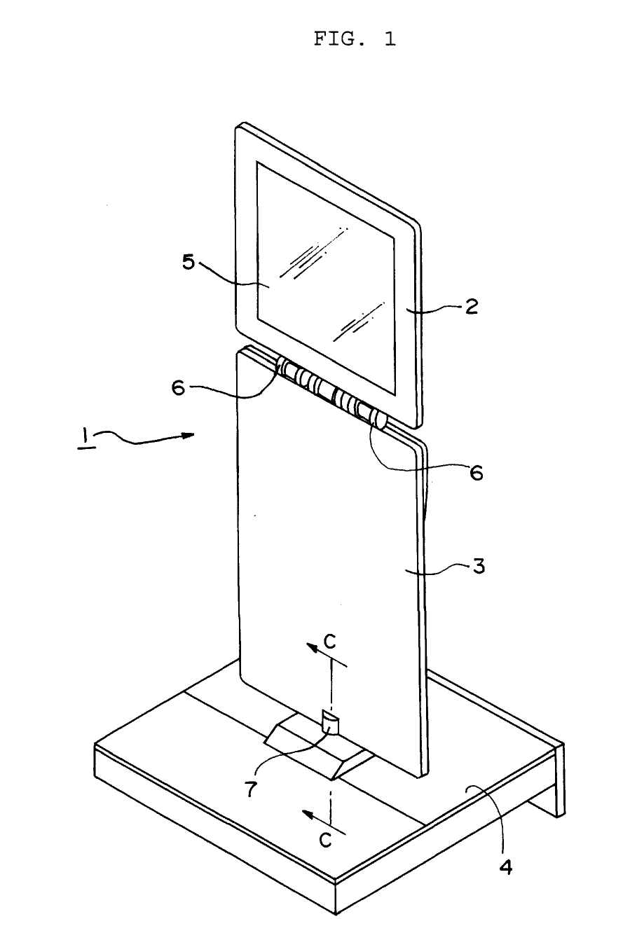

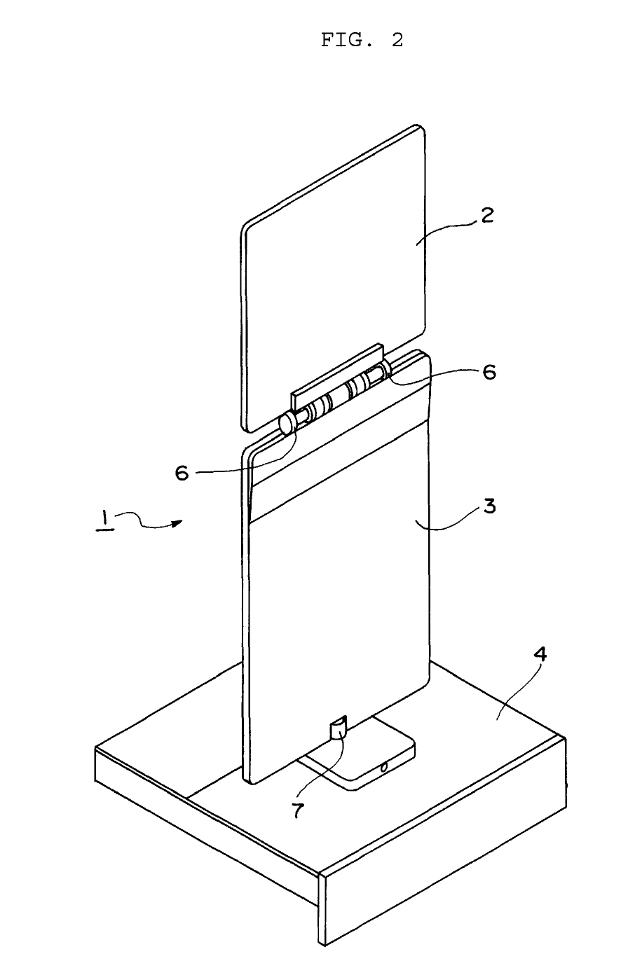

Hereafter, a lighting apparatus in accordance with the present invention will be described with reference to the preferred embodiments as shown in the drawings. FIGS. 1 and 2 show the whole structure. FIG. 1 is a perspective view from above of the lighting apparatus at some angle on the front side, and FIG. 2 is a perspective view from above of the lighting apparatus at some angle on the back side.

As shown in FIGS. 1 and 2, this lighting apparatus 1 is constituted by a rectangular light emitting panel 2, a support member (hereafter simply referred to as panel support member) 3 of the light emitting panel which is similarly formed in the shape of a rectangle and in the shape of a board (in the shape of a panel), and a seat 4 formed in the shape of a casing in order from top.

As described above, the light emitting panel 2 is generally formed in the shape of a rectangle, a light emitting part 5 which is in the shape of a substantial square and formed of the organic EL element is attached to one of its surfaces, and the above-mentioned light emitting panel 2 is formed in the shape of a frame around the above-mentioned light emitting part 5.

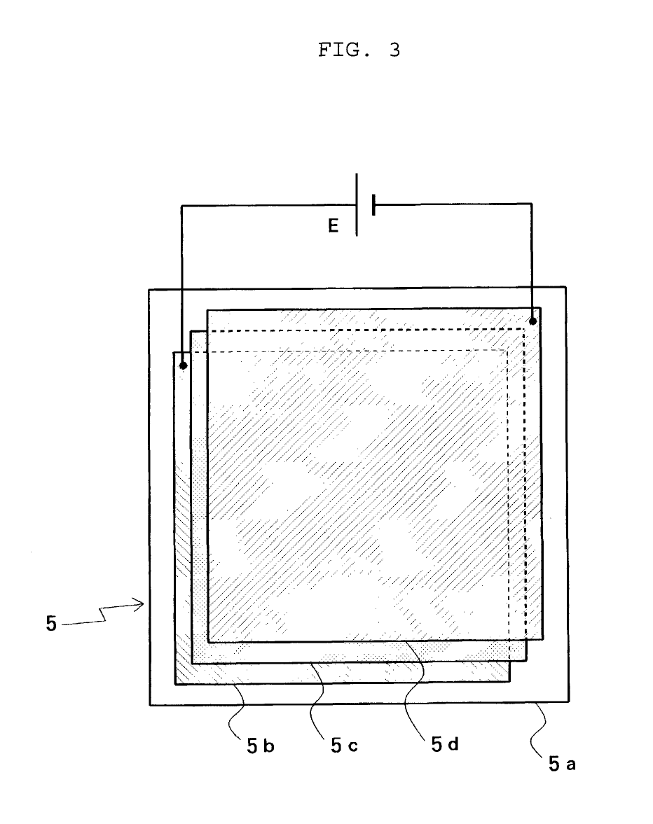

FIG. 3 is for explaining an example of a structure of the above-mentioned organic EL element (indicated by the same reference numeral 5 as that of the light emitting part) as the light emitting part 5. In FIG. 3, it is illustrated in a situation where respective layers constituting the organic EL element 5 are separated in a layer direction. In other words, as for the organic EL element 5 of this type, a transparent electrode 5b made of ITO (for example) and used as a first electrode is formed at one surface of a substrate 5a formed of a transparent material, such as glass.

Further, an organic luminescence layer 5c is formed as a film so as to be stacked on the above-mentioned transparent electrode 5b. Although this organic luminescence layer is constituted by, for example, a hole transport layer, a luminescence layer, an electronic transport layer, etc., it is represented by the organic luminescence layer 5c with one layer in the drawing. A counter electrode 5d which serves as a second electrode and is made of aluminum etc., for example, is formed so as to be stacked on the above-mentioned organic luminescence layer 5c.

In addition to this, although not shown in the drawings, a sealing substrate is disposed at the back side of the counter electrode 5d, and this sealing substrate is sealed by a sealing member at a circumferential edge of the above-mentioned glass substrate 5a on a front side.

A direct-current power source E is connected between the above-mentioned transparent electrode 5b and the counter electrode 5d, whereby a portion sandwiched between the above-mentioned transparent electrode 5b and the counter electrode 5d at the organic luminescence layer 5c emits light which is conducted to the outside through the above-mentioned transparent electrode 5b and the glass substrate 5a.

As shown in FIGS. 1 and 2, the light emitting panel 2 having mounted thereon the light emitting part 5 formed of the above-mentioned organic EL element is swivelingly attached to one side of an upper end of the panel support member 3 through a hinge member (indicated by the same reference numeral 6 as that of a first connection part) as the first connection part 6 at one side of a lower end of the light emitting panel 2. In other words, the light emitting part 5 in the above-mentioned light emitting panel 2 is arranged so that the hinge member 6 which functions as the above-mentioned first connection part can adjust a depression angle and an elevation angle. In addition, the detailed structure of the above-mentioned hinge member 6 will be described later.

The above-mentioned panel support member 3 is formed in the shape of a longitudinal rectangle, and is rotatably supported in the center of the seat 4 which is formed in the shape of a casing through a pivot mechanism (indicated by the same reference numeral 7 as that of the second connection part) which functions as the second connection part 7 in the center of the lower end.

In other words, the above-mentioned panel support member 3 is supported on the seat 4 by the pivot mechanism 7 so as to horizontally rotate, whereby the light emitting part 5 in the above-mentioned light emitting panel 2 is arranged so that a horizontal orientation may be adjusted by the pivot mechanism 7 as the above-mentioned second connection part. In addition, a detailed structure of the above-mentioned pivot mechanism 7 will be described later.

Further, the above-mentioned seat 4 is constituted by the casing which is generally formed in a flat shape, and a drive power-source (not shown) for lighting and driving the above-mentioned light emitting part 5 is accommodated in the above-mentioned casing. This drive power-source may be provided with an AC-DC converter which generates a low DC voltage from a commercial AC power supply. It may be provided with a battery, or a DC-DC converter for boosting a battery voltage, if needed.

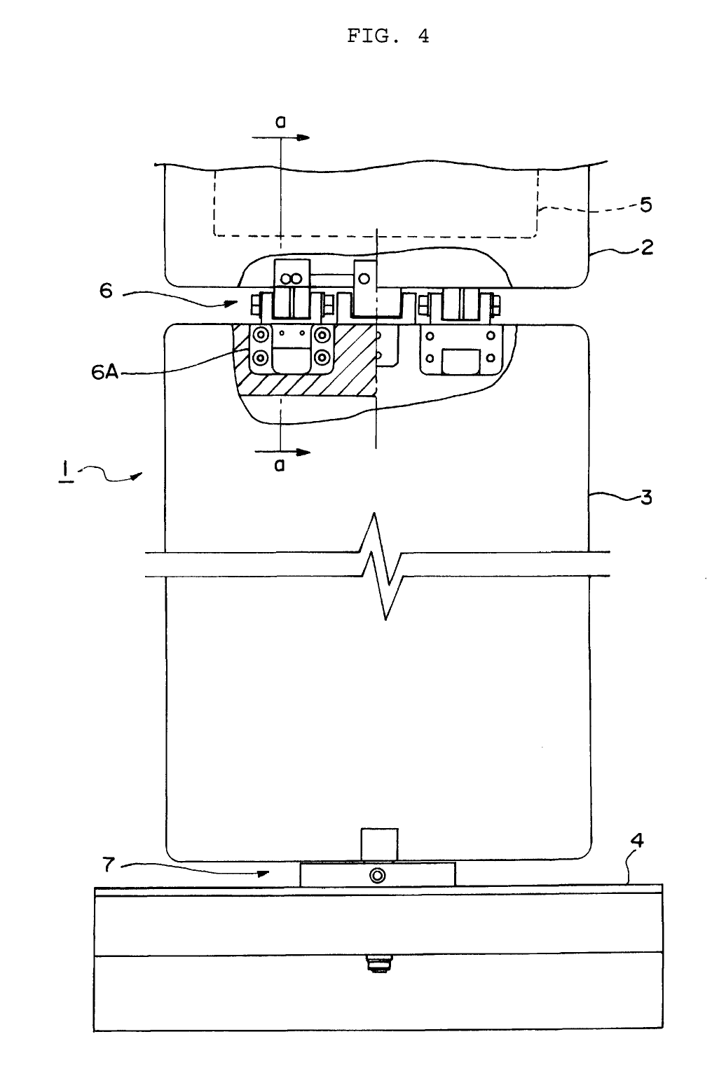

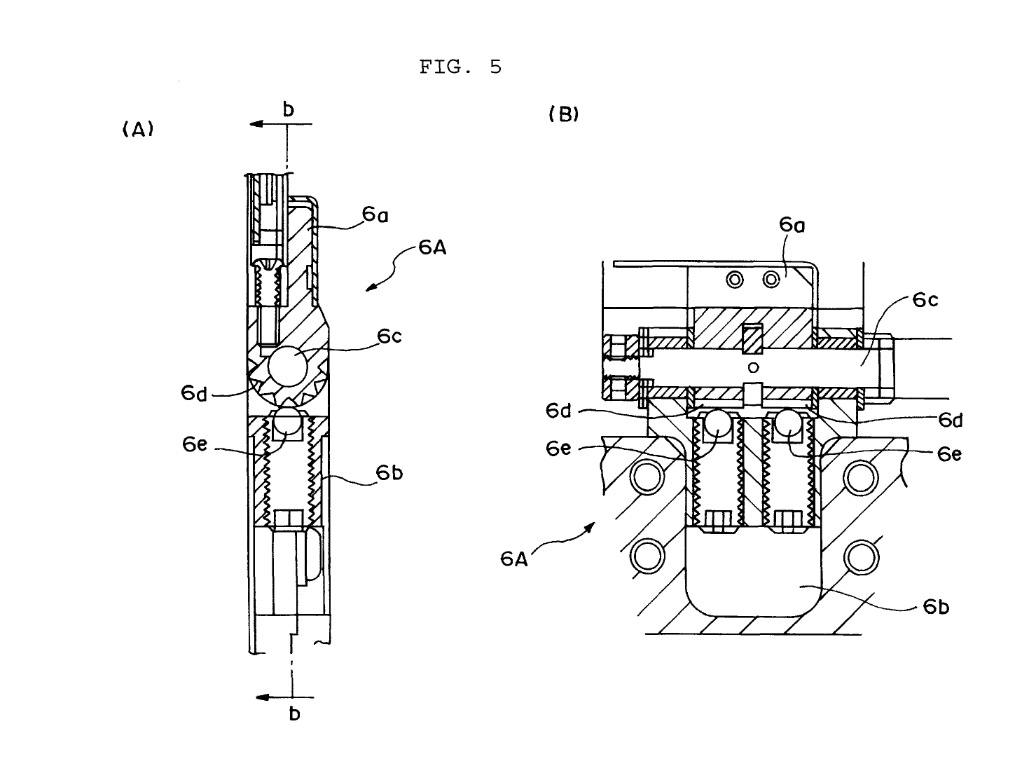

FIG. 4 enlarges and shows a situation where the principal parts of the hinge member 6 as the above-mentioned first connection part and the pivot mechanism 7 as the second connection part are viewed from behind a lighting device 1. The hinge member 6 as the first connection part in this preferred embodiment is constituted by three hinge brackets. An enlarged sectional view in a situation where it is viewed in the direction of arrows from line a-a which passes along one hinge-bracket 6A of the three is illustrated in FIG. 5(A). Further, FIG. 5(B) shows a sectional view in a situation where it is viewed in the direction of arrows from line b-b is shown in FIG. 5(A).

As shown in FIG. 5, the above-mentioned hinge-bracket 6A is constituted by an upper member 6a attached to the above-mentioned light emitting panel 2 side and a lower member 6b attached to the above-mentioned panel support member 3 side. It is arranged that both ends of a horizontal shaft 6c whose center is supported by the upper member 6a are swivelingly pivoted by a bifurcated portion of the lower member 6b.

As shown in FIG. 5(A), a large diameter portion is formed at the upper member 6a supporting the horizontal shaft 6c concentrically about the horizontal shaft 6c and the large diameter portion has formed therein a gear-like knurl 6d along a lower semicircle. Further, in the lower member 6b which constitutes the hinge-bracket 6A, a ball 6e is supported to project upward, and this ball 6e abuts the gear-like knurl 6d formed at the above-mentioned the upper member 6a.

In other words, the hinge-bracket 6A has formed therein a detent mechanism by means of the above-mentioned gear-like knurl 6d and the ball 6e in abutment therewith. According to this detent mechanism, the above-mentioned light emitting panel 2 operates to adjust the depression angle and the elevation angle of the light emitting part 5 by a predetermined angle (every 30 degrees in this preferred embodiment).

As shown in FIG. 5(B), a pair of above-mentioned detent mechanism including the knurl and the ball is formed at the hinge-bracket 6A. Of these three hinge brackets as shown in FIG. 4, except for the central hinge bracket, the detent mechanisms having the same structure are formed at other outer hinge brackets.

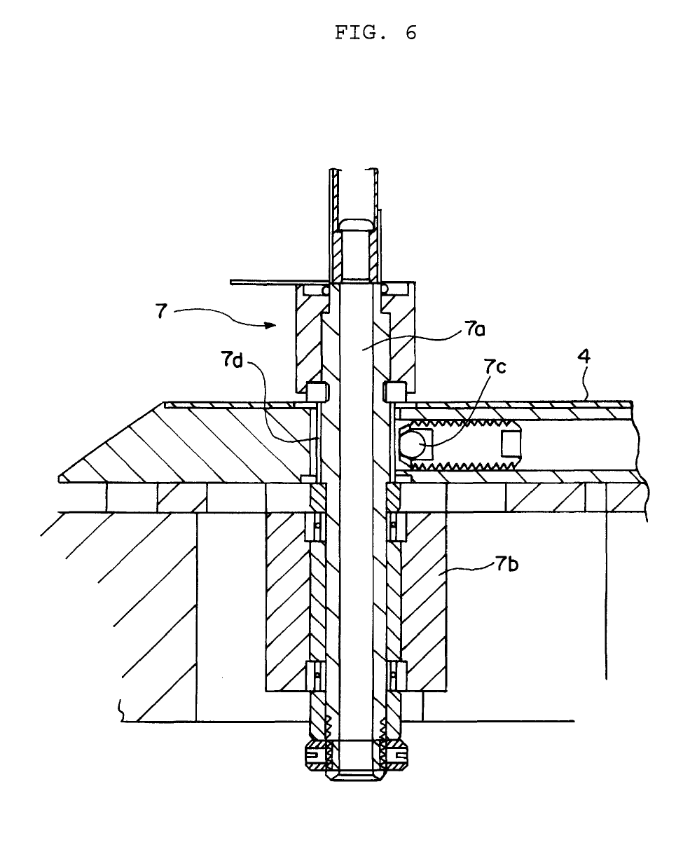

On the other hand, the principal part of the pivot mechanism 7 as the second connection part as shown in FIG. 4 is illustrated in FIG. 6 as an enlarged sectional view. In addition, the enlarged sectional view as shown in FIG. 6 is also an enlarged sectional view from line c-c as shown in FIG. 1.

In FIG. 6, reference numeral 7a indicates a shaft member which supports the panel support member 3 at its lower end. This shaft member 7a is inserted through a bearing unit 7b attached to the seat in the center of the seat 4, and is rotatably supported. The ball 7c is disposed in the above-mentioned seat 4 so as to abut a circumferential side wall of the above-mentioned shaft member 7a. Along the circumferential surface, a gear-like knurl 7d is formed in this abutment position of the above-mentioned ball 7c at the above-mentioned shaft member 7a.

In other words, similar to the gear-like knurl 6d as shown in FIG. 5(A), the gear-like knurl 7d is formed on the circumferential surface of the above-mentioned shaft member 7a, and constitutes a detent mechanism together with the above-mentioned ball 7c which abuts this knurl 7d. According to this detent mechanism, the above-mentioned panel support member 3 is adjusted and allowed to rotate horizontally by a predetermined angle (every 30 degrees in this preferred embodiment).

Since the light emitting part 5 in the above-mentioned light emitting panel 2 can be stopped in any attitude by operation of the detent mechanism formed at the hinge member 6 as the above-mentioned first connection part and the detent mechanism formed at the pivot mechanism 7 as the second connection part, it can be easily handled, and it is possible to provide its original operational effects.

Further, by arranging the lighting apparatuses, for example, in an event place, a hall facility, etc., and along the walls of their corridors and stairs, so as to mainly illuminate the walls, it is possible to demonstrate the function of the indirect illumination light as footlights (step lights). Furthermore, this lighting apparatus can also be used for others, such as a desk lamp and a spotlight.

In addition, in the preferred embodiments as described above, although the panel support member 3 is formed to have substantially the same width as that of the light emitting panel 2 which is mounted thereon, the width of this panel support member 3 may be arranged to be narrower than the width of the light emitting panel 2. Alternatively, it may be arranged to be wider.

Further, in the preferred embodiments, although the organic EL element is used for the light emitting part 5, an inorganic EL element or other plane light-emitters can also be used. Furthermore, according to usage, it is possible to employ a structure where the light emitting parts 5 are formed at both surfaces of the light emitting panel 2 respectively.

Furthermore, in the preferred embodiments, the hinge member is used as the above-mentioned first connection part 6. However, by using a universal joint (for example) as this first connection part 6, other attitudes, including the depression angle and the elevation angle, can also be adjusted for the light emitting part 5 in the light emitting panel 2.

Still further, it is possible to arrange that the above-mentioned panel support member 3 may also have formed the plane light emitting part and both the light emitting part 5 attached to the luminescence panel 2 and the light emitting part attached to the panel support member 3 may be lit or selectively lit.

Which is claimed is:

1. A lighting apparatus, comprising a light emitting panel in which a light emitting part is formed at least at one surface, a panel support member for swivelingly supporting said light emitting panel through a first connection part at an end of said light emitting panel, and a seat for swivelingly supporting said panel support member through a second connection part at a lower end of said panel support member, wherein
said light emitting part in said light emitting panel is arranged such that at least a depression angle and an elevation angle can be adjusted by said first connection part and a horizontal orientation can be adjusted by said second connection part.

2. The lighting apparatus as claimed in claim 1, wherein said light emitting panel and the panel support member are formed in the shape of a rectangular panel respectively, and said light emitting panel and the panel support member are connected together at a side for each through a hinge member which constitutes said first connection part.

3. The lighting apparatus as claimed in claim 1, wherein said panel support member is rotatably set up on said seat through a pivot mechanism which constitutes said second connection part.

4. The lighting apparatus as claimed in any one of claims 1 to 3, wherein a detent mechanism is further provided for said first connection part and/or second connection part, and said light emitting panel may be stopped by said detent mechanism.

5. The lighting apparatus as claimed in claim 1, wherein said light emitting part is constituted by an organic EL element.

6. The lighting apparatus as claimed in claim 1, wherein said seat is constituted by a casing in which a drive power-source for lighting and driving said light emitting part is accommodated.
